(19) United States
(12) Patent Application Publication
(10) Pub. No.: US 2026/0167193 A1
(43) Pub. Date: Jun. 18, 2026

(54) METHOD OF BRAKING AUTONOMOUS VEHICLE ON SLOPE AND AUTONOMOUS VEHICLE

(71) Applicants: Hyundai Motor Company, Seoul (KR); Kia Corporation, Seoul (KR)

(72) Inventor: Jung Hwan Lee, Hwaseong-Si (KR)

(21) Appl. No.: 19/302,885

(22) Filed: Aug. 18, 2025

(30) Foreign Application Priority Data
Dec. 17, 2024 (KR) 10-2024-0188773

(51) Int. Cl. B60W 30/18; B60W 10/04; B60W 10/18; B60W 30/16; B60W 60/00

(52) U.S. Cl. CPC B60W 30/18118; B60W 10/04; B60W 10/18; B60W 30/162; B60W 60/001; B60W 2420/403; B60W 2420/408; B60W 2510/081; B60W 2510/182; B60W 2520/04; B60W 2520/105; B60W 2520/28; B60W 2540/12; B60W 2552/15; B60W 2554/4041; B60W 2554/802; B60W 2710/182

(57) ABSTRACT

Provided is a method of braking an autonomous vehicle stopped on a sloped surface. The method includes detecting a roll down of the first vehicle that stopped while adaptive cruise control of the first vehicle is engaged. Detecting the roll down is based on: whether the first vehicle stops on an uphill slope; whether a distance to a second vehicle in front of the first vehicle increases; whether a signal of a wheel sensor of the first vehicle is detected; and/or whether an absolute value of a negative motor speed of the first vehicle increases and whether the signal of the wheel sensor indicates a rearward movement of the first vehicle. The method further includes: determining, based on the detecting of the roll down of the first vehicle, a braking pressure for the first vehicle; and controlling the first vehicle to brake according to the determined braking pressure.

This application claims priority to Korean Patent Application No. 10-2024-0188773, filed in the Korean Intellectual Property Office on Dec. 17, 2024, which is hereby incorporated by reference for all purposes.

### TECHNICAL FIELD

The present disclosure relates to an autonomous vehicle and an autonomous driving method of a vehicle.

### BACKGROUND OF THE DISCLOSURE

Some vehicles are equipped with autonomous driving systems to provide safety by reducing traffic accidents and traffic efficiency on the road. Many autonomous vehicles are environment-friendly and may offer fuel savings and other conveniences.

### SUMMARY

An object of the present disclosure is to determine possible occurrence of unintended rolling of a vehicle (e.g., a vehicle roll down) after the vehicle stops on a slope (e.g., by smart cruise control (SCC)) and to control the vehicle to prevent a collision with an adjacent vehicle.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

According to one or more example embodiments of the present disclosure, a method performed by an apparatus of a first vehicle may include: detecting a roll down of the first vehicle that stopped while adaptive cruise control of the first vehicle is engaged. Detecting the roll down may be based on at least one of: whether the first vehicle stops on an uphill slope; whether a distance, between the first vehicle and a second vehicle in front of the first vehicle, increases; whether a signal of a wheel sensor of the first vehicle is detected; or whether an absolute value of a negative motor speed of the first vehicle increases and whether the signal of the wheel sensor indicates a rearward movement of the first vehicle. The method may further include: determining, based on the detecting of the roll down of the first vehicle, a braking pressure for the first vehicle; and controlling the first vehicle to brake according to the determined braking pressure.

Detecting the roll down of the first vehicle may include: while a brake pedal of the first vehicle is not depressed by a driver of the first vehicle, determining that the first vehicle has stopped on the uphill slope based on: an acceleration of the first vehicle being detected for at least a threshold time duration; and a gradient of a road on which the first vehicle has stopped is greater than 0 degrees.

Detecting the roll down of the first vehicle may include: determining that the first vehicle has stopped on the uphill slope based on: an amount of change in a distance between the first vehicle and the second vehicle being greater than or equal to a threshold value.

Detecting the roll down of the first vehicle may include: determining that the first vehicle has stopped on the uphill slope based on: the signal of the wheel sensor indicating the rearward movement of the first vehicle and the signal of the wheel sensor being detected for at least a threshold time duration.

Detecting the roll down of the first vehicle may include: determining that the first vehicle has stopped on the uphill slope based on: the absolute value of the negative motor speed of the first vehicle increasing and an amount of change in the motor speed being less than or equal to a threshold value.

The method may further include transmitting, based on the detecting of the roll down of the first vehicle, an emergency stop request signal.

The braking pressure of the first vehicle may be a sum of a current braking pressure of the first vehicle and a target braking pressure.

The target braking pressure may be a product of an amount of change in a wheel speed of the first vehicle, an amount of change in a distance between the first vehicle and the second vehicle, and a proportional constant.

According to one or more example embodiments of the present disclosure, a method performed by an apparatus of a first vehicle may include: detecting a roll down of the first vehicle that stopped while adaptive cruise control of the first vehicle is engaged. Detecting the roll down may be based on at least one of: whether the first vehicle stops on a downhill slope; whether a distance, between the first vehicle and a second vehicle in front of the first vehicle, decreases; whether a signal of a wheel sensor of the first vehicle is detected; or whether a motor speed of the first vehicle increases and whether the signal of the wheel sensor indicates a forward movement of the first vehicle. The method may further include: determining, based on the detecting of the roll down of the first vehicle, a braking pressure for the first vehicle; and controlling the first vehicle to brake according to the determined braking pressure.

Detecting the roll down of the first vehicle may include: while a brake pedal of the first vehicle is not depressed by a driver of the first vehicle, determining that the first vehicle has stopped on the downhill slope based on: an acceleration of the first vehicle being detected for at least a threshold time duration; and a gradient of a road on which the first vehicle has stopped is less than 0 degrees.

Detecting the roll down of the first vehicle may include: determining that the first vehicle has stopped on the downhill slope based on: an amount of change in a distance between the first vehicle and the second vehicle being greater than or equal to a threshold value.

Detecting the roll down of the first vehicle may include: determining that the first vehicle has stopped on the downhill slope based on: the signal of the wheel sensor indicating the forward movement of the first vehicle and the signal of the wheel sensor being detected for at least a threshold time duration.

Detecting the roll down of the first vehicle may include: determining that the first vehicle has stopped on the downhill slope based on: the motor speed of the first vehicle increasing and an amount of change in the motor speed being less than or equal to a threshold value.

The method may further include transmitting, based on the detecting of the roll down of the first vehicle, an emergency stop request signal.

The braking pressure of the first vehicle may be a sum of a current braking pressure of the first vehicle and a target braking pressure.

The target braking pressure may be a product of an amount of change in a wheel speed of the first vehicle, an amount of change in a distance between the first vehicle and the second vehicle, and a proportional constant.

According to one or more example embodiments of the present disclosure, an autonomous vehicle may include: a wheel sensor configured to measure a wheel rotational speed of wheels of the autonomous vehicle; a front camera, a front radar, and a front-side radar configured to measure a distance from the autonomous vehicle to an object in front of the autonomous vehicle; a motor sensor configured to measure a motor rotational speed of a motor of the autonomous vehicle; an adaptive cruise control system; and a brake controller. The object may be in a same driving lane or in an adjacent driving lane as the autonomous vehicle. The adaptive cruise control system may be configured to: maintain a distance between the autonomous vehicle and the object; and receive a measurement value of at least one of the front camera, the front radar, or the front-side radar, the wheel rotational speed, and the motor rotational speed. The brake controller may be configured to receive an output value from the adaptive cruise control system and determine a target braking pressure of the autonomous vehicle to control a roll down of the autonomous vehicle.

The brake controller may be further configured to: apply, based on the roll down of the autonomous vehicle being detected after the autonomous vehicle has stopped, braking to the autonomous vehicle with an adjusted braking pressure. The adjusted braking pressure may be a sum of a current braking pressure of the autonomous vehicle and the target braking pressure.

The adaptive cruise control system may be further configured to: detect the roll down of the autonomous vehicle by determining that the autonomous vehicle has stopped on an uphill slope based on: an acceleration of the autonomous vehicle being detected for at least a threshold time duration; and a gradient of a road on which the autonomous vehicle has stopped is greater than 0 degrees.

The adaptive cruise control system may be further configured to: detect the roll down of the autonomous vehicle by determining that the autonomous vehicle has stopped on a downhill slope based on: an acceleration of the autonomous vehicle being detected for at least a threshold time duration; and a gradient of a road on which the autonomous vehicle has stopped is less than 0 degrees.

### BRIEF DESCRIPTION OF THE DRAWINGS

The accompanying drawings, which are included to provide a further understanding of the disclosure and are incorporated in and constitute a part of this application, illustrate example embodiment(s) of the disclosure and together with the description serve to explain the principle of the disclosure. In the drawings:

FIG. 1 is a diagram illustrating an example autonomous vehicle having a smart cruise control (SCC) function;

FIG. 2 is a diagram illustrating a configuration of an autonomous vehicle;

FIG. 3 is a diagram illustrating an autonomous driving method of a vehicle;

FIG. 4 and FIG. 5 are graphs showing methods of setting a proportional constant k and a target braking pressure P_{target};

FIG. 6 and FIG. 7 illustrate vehicle speeds, motor speeds, and accelerator pedal statuses when backward rolling occurs and when it does not occur; and

FIG. 8 shows an example computing system.

### DETAILED DESCRIPTION

Hereinafter, one or more example embodiments of the present disclosure will be described in detail with reference to exemplary drawings. In adding reference numerals to components in each figure, it should be noted that the same components are given the same numerals as much as possible even if they are shown in different figures. In addition, in describing the example embodiment(s) of the present disclosure, if it is determined that a specific description of a related known configuration or function hinders the understanding of the example embodiment(s) of the present disclosure, the detailed description thereof will be omitted.

In the description of example embodiment(s) according to the present disclosure, a case where an element is described as being formed “on or under” of another element includes both a case where the two elements are directly in contact with each other and a case where one or more other elements are formed between the two elements. In addition, the expression of “on or under” can include the meaning of not only the upward direction but also the downward direction based on one element.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Unless otherwise defined, the terms used herein, including technical or scientific terms, may have meanings generally understood by those skilled in the art to which the present disclosure belongs.

The expressions such as “comprise”, “may comprise”, “include”, “may include”, “have”, “may have”, etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip”, “second chip”, respectively.

The expression “based on” as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to”, “with the ability to”, “modified to”, “made to”, “to be able to”, etc. This expression is not limited to the meaning of “specially designed in hardware to”. For example, a processor configured to perform a specific operation may refer to a generic purpose processor capable of performing the specific operation by executing software, or to a special purpose computer structured through programming to perform the specific operation.

Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

One or more controllers described herein may include one or more processors, one or more memory and/or one or more storage devices. One or more controllers of the vehicle may disable operation control of one or more components of the vehicle, based on a result of one or more authentication processes and/or verification processes described herein. The vehicle components may include one or more sensors (e.g., camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, etc.), for example, for autonomous driving control. The vehicle components may also include an auxiliary braking system (e.g., hydraulic retarder, electric retarder), an auxiliary device (e.g., engine brake, exhaust brake, hydraulic retarder, electric retarder, regenerative brake, etc.), a motor, a battery management system, a battery, a communication interface, a controller, a user interface, a key fob, a steering wheel, etc.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., detection of an accidental vehicle roll down) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., detection of an accidental vehicle roll down) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., detection of an accidental vehicle roll down) described herein.

Minimum risk maneuver (MRM) operation(s) may also be controlled, for example, based on one or more features (e.g., detection of an accidental vehicle roll down) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., detection of an accidental vehicle roll down) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

An autonomous driving level and/or autonomous driving activation/deactivation may also be controlled, for example, based on one or more features (e.g., detection of an accidental vehicle roll down) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., detection of an accidental vehicle roll down) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, driver warning control, autonomous driving operational design domain (ODD), etc.).

The vehicle that an autonomous driving system is actively controlling may be referred to as an ego vehicle, a host vehicle, or an autonomous vehicle. The ego vehicle may also be referred to as a self-driving car, an autonomous car (AC), a driverless car, a robotaxi, a robotic car, or a robo-car. The ego vehicle may be the vehicle that is equipped with the autonomous driving system. A car that is ahead of the ego vehicle (e.g., in the same driving lane as the ego vehicle) may be referred to as a vehicle in front (e.g., a vehicle directly in front), a vehicle ahead (e.g., a vehicle directly ahead), a lead vehicle, a leading vehicle, or a preceding vehicle. A car that follows the ego vehicle (e.g., in the same driving lane as the ego vehicle) may be referred to as a car behind, a trailing vehicle, or a succeeding vehicle. An adjacent vehicle may refer to any vehicle located in any direction (e.g., front, rear, left, right, diagonal, etc.) from the ego vehicle as long as no other vehicles (e.g., intervening vehicles) exist between it and the ego vehicle (e.g., regardless of the distance from the ego vehicle). Alternatively, in some contexts, only those vehicles that are located within a threshold distance (e.g., line of sight and/or detection limit of one or more sensors of the ego vehicle) from the ego vehicle may be referred to as adjacent vehicles. A target vehicle may be any vehicle that is near the ego vehicle (e.g., within a threshold distance away from the ego vehicle). The target vehicle may be any vehicle that the autonomous driving system monitors, recognizes, identifies, tracks, and/or analyzes, either actively or passively, either once or multiple times, and either sporadically or continuously. The threshold distance may be, for example, the line of sight and/or the detection limit of one or more sensors of the ego vehicle, but the threshold distance may be a value (e.g., an adjustable value) that is less than the line of sight and/or the detection limit of the one or more sensors of the ego vehicle. The target vehicle can be, for example, a vehicle in front, a vehicle behind, a vehicle in a different lane than the driving lane of the ego vehicle (e.g., a vehicle to the left, a vehicle to the right, a vehicle in a diagonal direction, etc.), and/or an adjacent vehicle (e.g., regardless of the distance from the ego vehicle and/or regardless of whether there are intervening vehicle(s) between the target vehicle and the ego vehicle). A target vehicle may also be referred to as a surrounding vehicle, a nearby vehicle, an external vehicle, another vehicle (other vehicles), and so forth.

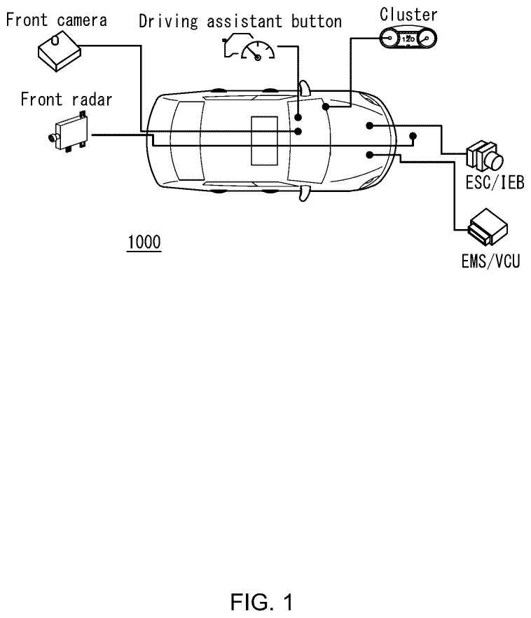

FIG. 1 is a diagram showing an example autonomous vehicle having a smart cruise control (SCC) function.

An autonomous vehicle 1000 shown in FIG. 1 may be an electric or hybrid vehicle. The autonomous vehicle 1000 may be equipped with a front camera and a front radar for identifying a front vehicle and the like, a cluster (e.g., an instrument cluster) and driving assistance buttons provided inside the vehicle to for the driver's convenience, an electronic stability controller (ESC) 200 for generating (e.g., controlling) engine torque and braking torque in accordance with a required acceleration, an integrated electric booster (IEB) operating as an electronic brake, an energy management system (EMS) for evenly balancing the load inside the electric vehicle and ensuring efficient use of electric resources, and a vehicle control unit (VCU) for controlling the operation characteristics of the electric vehicle.

The autonomous vehicle 1000 may have driving convenience functions of recognizing a target using sensors such as a front radar and a front camera, and assisting the vehicle in traveling at a speed set by the driver while maintaining a distance to a lead vehicle (e.g., SCC).

Specifically, a distance between vehicles may be selected from levels 1 through 4, and the autonomous vehicle may automatically (e.g., with little or no human intervention) travel while maintaining a distance (e.g., a safe distance) between vehicles and a set speed. In addition, the autonomous vehicle may automatically stop (e.g., come to a full stop) when the lead vehicle stops, and automatically start if the lead vehicle starts (e.g., within three seconds of the target vehicle coming to a full stop). Further, after a predetermined amount of time (e.g., three seconds), the autonomous vehicle may start when the driver depresses the accelerator pedal or operates a (+) switch, a (−) switch, or a pause/resume button. At this time, a pop-up may be displayed after the predetermined time amount (e.g., three seconds) to inform the driver of the starting method.

A Hill-Start Assist Control (HAC) may be a system for preventing vehicle rolling (e.g., a vehicle roll down) on a slope. The HAC can prevent vehicle rolling by increasing the braking pressure when starting after stopping on a slope.

However, in some implementations, an autonomous vehicle, such as the one shown in FIG. 1, may have the following problems.

Even if a braking pressure for a slope is set during a vehicle stop caused by the SCC, the vehicle may roll backward immediately after stopping due to factors such as overloading. At this time, although SCC requires the driver to watch the road ahead, it may be difficult for the driver to recognize and respond within a short period of time when the vehicle rolls backwards during stopping since the vehicle is not driven by the driver.

In addition, hill rolling prevention systems at least in some implementations may be designed to prevent a vehicle from rolling when the vehicle starts from a stopped position, and thus they may not be designed to present rolling while the vehicle is stopped (e.g., by the SCC).

To solve these problems, a vehicle roll down due to restarting after a stop when a driver is driving a vehicle on a slope or preventing rolling while parking, but hill-start control according to SCC may not necessarily consider acceleration/deceleration compensation in advance when driving forward.

Therefore, specific technology regarding follow-up measures to deal with rolling when it occurs after stopping by SCC is required.

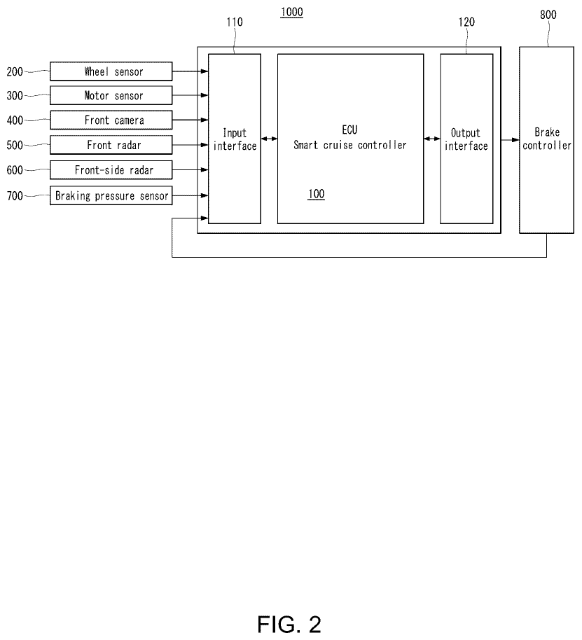

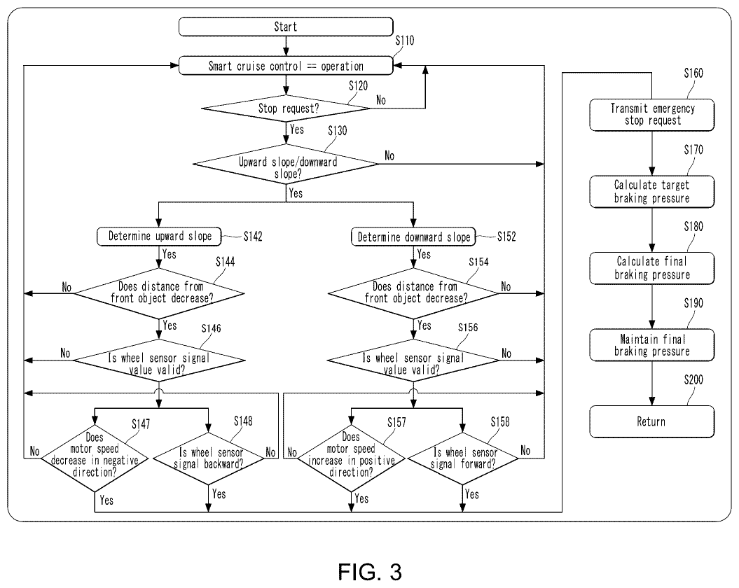

FIG. 2 is a diagram showing a configuration of an autonomous vehicle, and FIG. 3 is a diagram showing an autonomous driving method of a vehicle. Hereinafter, the autonomous vehicle and the autonomous driving method of a vehicle will be described with reference to FIG. 2 and FIG. 3.

Referring to FIG. 2, the autonomous vehicle 1000 may be, for example, an electric vehicle or a hybrid vehicle, and an electronic control unit (ECU) 100 may control all components provided in the vehicle, such as an engine and a transmission, and in particular, may control a smart cruise control function.

The ECU 100 receives various types of information such as a distance to a lead vehicle from a wheel sensor 200, a motor sensor 300, a front camera 400, a front radar 500, a front-side (e.g., front-left or front-right) radar 600, a braking pressure sensor 700, and the like through an input interface 110, and can control operation of a brake controller 800 through output interface 120.

Referring to FIG. 3, a vehicle starts to travel and the smart cruise control function is operated (S110). Smart cruise control (SCC) may also be referred to as adaptive cruise control (ACC). SCC may be a driver-assistance system that automatically (e.g. with little or no human intervention) adjusts the speed of the vehicle (e.g., the host vehicle) to maintain a safe distance from a target vehicle ahead (e.g., a lead vehicle). The safe distance may be, for example, a constant distance. The safe distance may be a variable distance that changes according to the speed of the host vehicle. For example, the safe distance may be within a predetermined range of distances that is determined (e.g., adjusted) based on the speed of the host vehicle.

It may be determined whether there is a stop request (S120), driving by SCC (e.g., driving with SCC engaged) is continued if there is no stop request (No), and the vehicle stops if there is a stop request (Yes). A stop request may be also referred to as a stop command. The stop request may be issued, for example, by a depressed brake pedal. For example, the stop request may be issued by SCC without a brake pedal of the vehicle being depressed by a driver of the vehicle. At this time, it is determined whether the vehicle has stopped on a slope (S130).

In the above-described step S120, determination of whether there is a stop request may be performed by determining whether a distance (e.g., a following distance) to a front object (e.g., an object ahead), such as a lead vehicle, is less than or equal to a first reference value (Cal. 1) and whether the speed of the vehicle is less than or equal to a second reference value (Cal. 2). That is, if the distance to the front object is less than or equal to the first reference value and the speed of the vehicle is less than or equal to the second reference value, it may be determined that there is a stop request for the vehicle. If the distance to the front object is greater than the first value, it is possible to determine that the vehicle will not stop because a sufficient safety distance to the front vehicle is secured, and if the speed of the vehicle is greater than the second value, it is possible to determine that the vehicle is traveling.

Here, the distance to the front object may be measured by the aforementioned front camera 400, front radar 500, and front-side radar 600 and input to the smart cruise controller 100 through the input interface 110.

In FIG. 3, “uphill” means an uphill road in a direction of travel of the vehicle, and “downhill” means a downhill road in a direction of travel of the vehicle.

If the road on which the vehicle stops is not an uphill or downhill road (No), that is, if the road is a flat road, driving by SCC is continued, and if the road is an uphill or downhill road (Yes), it is determined whether it is an uphill road or a downhill road.

At this time, whether the vehicle stops on a slope may be determined by determining the direction of movement of the vehicle on the basis of a signal value of the wheel sensor 200 or a motor speed measured by the motor sensor 300 and determining a distance to a front object through a front object detection sensor such as the front radar, the front camera, or the front-side radar, which will be described later.

Whether the stopped location of the vehicle is a sloped or inclined surface (e.g., an uphill or downhill road) may be determined by the smart cruise controller 100 in FIG. 2 by, for example, using Equation 1.

$$θ = {sin}^{- 1} ( {a}_{g} / g ) \qquad [ Equation 1 ]$$

Here, θ is the gradient of a road, that is, an angle with respect to the horizontal plane, a_{g} is an acceleration of a vehicle detected by an acceleration sensor provided in the vehicle, and g is acceleration due to gravity.

If the gradient θ determined using the Equation 1 is greater than 0° and t_{decision} is greater than or equal to a first time, for example, 500 milliseconds (ms), the slope may be determined to be an upward slope, and if the gradient θ is less than or equal to 0° and t_{decision} is less than or equal to a second time, for example, 500 milliseconds (ms), the slope may be determined to be a downward slope. Here, t_{decision} represents the time for which the acceleration of the vehicle is detected as being other than 0, that is, the time for which an acceleration due to rolling of the vehicle is detected. That is, in order to distinguish rolling from a pitch motion in which the vehicle shakes in the longitudinal direction for a short time when it stops, it is determined that the vehicle stops on an uphill or downhill road only when the time for which the vehicle accelerates forward or backward is at least 500 milliseconds.

Upon determining that the vehicle is located on an uphill road (Yes) in step S142, the following steps are additionally performed.

First, it is determined whether a distance to an object in front of the vehicle, for example, a lead vehicle, increases (S144). If the distance increases (Yes), the vehicle may be rolling backward, and thus the vehicle may be located on an uphill road. If not (No), driving by SCC can be continued.

That is, if the vehicle stops on an uphill road, the vehicle may roll backward, and thus the distance to a front object, such as a lead vehicle, may increase, and the wheels may also turn backward. Therefore, if the amount of change Δd in the distance between the vehicle and the front object is greater than or equal to a third value, it can be determined that the vehicle stops on an uphill road.

Then, it is determined whether a signal value of the wheel sensor is valid (S146), the next step is performed if the signal value of the wheel sensor is valid (Yes), and driving by SCC is continued if not (No). Here, “the signal value of the wheel sensor is valid” means that when the vehicle stops on a slope, for example, on an uphill slope, and slides backward, rotation of the wheels is detected by the wheel sensor. For example, the signal value being valid may indicate that the signal value is detected or registered (e.g., at the input interface 110).

When the vehicle stops on an uphill slope and slides backward, the motor speed of the engine may decrease in the negative direction, or the signal value of the wheel sensor may be backward.

Therefore, it is determined whether the motor speed of the engine decreases in the negative direction (S147), it is determined that the vehicle stops on an uphill slope and if it decreases in the negative direction (Yes), and driving by SCC is continued if not (No). In addition, when the motor speed of the engine increases to a negative value, and the amount of change ΔVₘₒₜₒᵣ in the motor speed of the engine is less than or equal to a fourth value, it is possible to determine that the vehicle stops on an uphill slope.

In addition, it is determined whether the signal value of the wheel sensor is backward (S148), it is determined that the vehicle stops on an uphill slope if the signal value is backward (Yes), and driving by SCC is continued if not (No).

At this time, even if the signal value of the wheel sensor is backward, it can be determined that the vehicle stops on an uphill slope only when t_{decision} is 500 milliseconds (ms) or more. As described above, in order to distinguish vehicle rolling from a pitch motion in which the vehicle shakes in the longitudinal direction for a short time when stopping, it is determined that the vehicle stops on an uphill slope only when the time for which the signal value of the wheel sensor of the vehicle is detected as backward is at least the third time, for example, 500 milliseconds.

Upon determining that the vehicle is located on a downhill slope (Yes) in step S152, the following steps are additionally performed.

First, it is determined whether the distance to a front object of the vehicle, for example, a lead vehicle, decreases (S154). If it decreases (Yes), the vehicle may roll forward and thus the vehicle may be determined to have stopped on a downhill slope, and otherwise (No), driving by SCC can be continued.

That is, if the vehicle stops on a downhill slope, the vehicle may roll forward, and thus the distance to a front object, such as a lead vehicle, may decrease, and the wheels may also turn forward. Therefore, if the amount of change Δd in the distance between the vehicle and the front object is greater than or equal to a fifth value, it can be determined that the vehicle stops on a downhill slope.

Then, it is determined whether a signal value of the wheel sensor is valid (S156), the next step is performed if the signal value of the wheel sensor is valid (Yes), and driving by SCC is continued otherwise (No). Here, “the signal value of the wheel sensor is valid” means that when the vehicle stops on a slope, for example, a downhill slope, and slides forward, the wheel sensor detects rotation of the wheels.

When the vehicle stops on a downhill slope and slides forward, the motor speed of the engine may increase in the positive direction, or the signal value of the wheel sensor may be forward.

Therefore, it is determined whether the motor speed of the engine increases in the positive direction (S157), it is determined that the vehicle stops on a downhill slope if the motor speed increases in the positive direction (Yes), and driving by SCC is continued if not (No). In addition, when the motor speed of the engine increases to a positive value, but the amount of change ΔVₘₒₜₒᵣ in the motor speed of the engine is equal to less than a sixth value, it can be determined that the vehicle stops on a downhill slope.

In addition, it is determined whether the signal value of the wheel sensor is forward (S158), it is determined that the vehicle stops on a downhill if the signal value is forward (Yes), and driving by SCC can be continued if not (No).

At this time, even if the signal value of the wheel sensor is forward, it can be determined the vehicle stops on a downhill only when t_{decision} is 500 milliseconds (ms) or longer. As described above, in order to distinguish vehicle rolling from a pitch motion in which the vehicle shakes in the longitudinal direction for a short time when stopping, it is determined that the vehicle stops on a downhill only when the time for which the signal value of the wheel sensor of the vehicle is detected as forward is at least the fourth time, for example, 500 milliseconds.

It may be possible to determine whether the vehicle stops on an uphill or downhill slope by considering both the signal value of the wheel sensor and the value of the motor speed of the engine, or in a situation where it is difficult to measure one of the two values, it is possible to determine whether the vehicle stops on an uphill or downhill slope by measuring only the remaining value.

In addition, t_{decision} is determined as a valid value only when it is 500 milliseconds (ms) or longer and is distinguished from a pitch motion, and it is determined that the vehicle stops on an uphill or downhill road only when the signal value of the wheel sensor or the amount of change in the motor speed of the engine is the third value to the sixth value or more, and thus cases such as vehicle rolling below a certain threshold can be excluded.

If the above steps S147, S148, S157, and S158 are determined as Yes, that is, if it is confirmed that the vehicle is positioned on a slope and rolling occurs, the smart cruise controller 100 may send an emergency stop request signal to, for example, the braking apparatus(S160).

In order to stop the vehicle from rolling on the slope, the brake controller 800 may determine a target braking pressure (S170). The amount of change Δd in the distance to the front object (e.g., a lead vehicle), the amount of change ΔV_{wheel} in the signal value of the wheel sensor, the motor speed of the engine, etc. may be transmitted from the smart cruise controller 10 to the brake controller 800 through the output interface 120. The target braking pressure P_{target} may be determined by using Equation 2.

$${P}_{target} = k \times Δ {V}_{wheel} \times Δ d \qquad [ Equation 2 ]$$

Here, k is a proportional constant, Δd is the aforementioned amount of change in the distance to the front object (e.g., a lead vehicle), and ΔV_{wheel} represents the amount of change in the speed (e.g., rotational speed) of the wheels.

Referring to Equation 2, as Δd increases, that is, as the amount of change in the distance to the front object increases, the vehicle may roll (e.g., roll down a sloped surface) for a longer distance and thus a higher braking pressure may need to be applied. Further, as ΔV_{wheel} increases, the wheels may rotate more rapidly and the vehicle may roll (e.g., roll down a sloped surface) at a higher speed, and thus a higher braking pressure may need to be applied. In addition, if both Δd and ΔV_{wheel} are measured as being large values (e.g., greater than a corresponding threshold value), the target braking pressure P_{target} may increase proportionally to the product of Δd and ΔV_{wheel}.

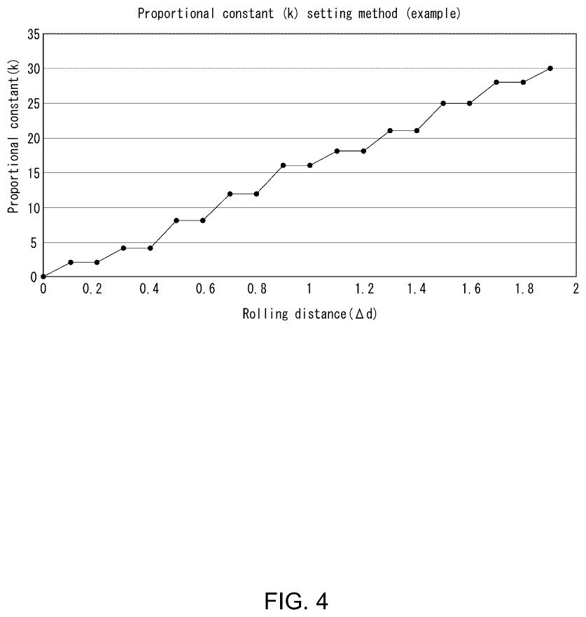

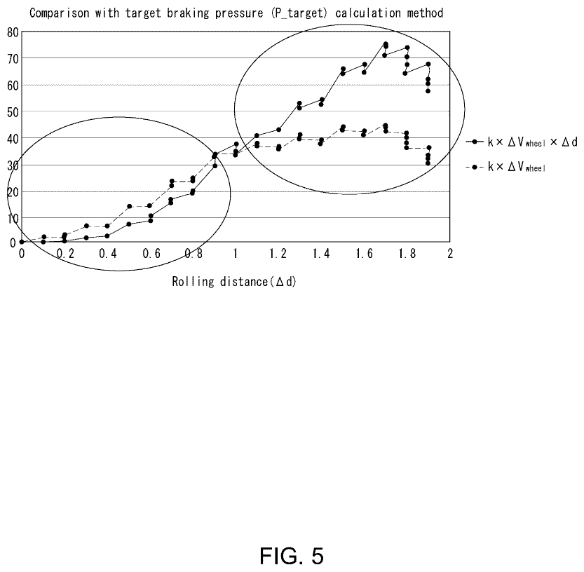

FIG. 4 and FIG. 5 are graphs showing methods of setting the proportional constant k and target braking pressure P_{target}. The graphs may be derived from empirical data measured from a vehicle that experienced rolling immediately after stopping on a slope while smart cruise control is engaged.

In FIG. 4, the proportional constant k tends to increase as a vehicle rolling distance Δd increases. In FIG. 5, when the vehicle rolling distance Δd increases, the value of target braking pressure P_{target}=k×ΔV_{wheel}×Δd indicated by a solid line increases, but the value of k×ΔV_{wheel} indicated by a dotted line does not increase when the rolling distance Δd exceeds a predetermined value.

A final braking pressure (also referred to as an adjusted braking pressure) may be determined based on the target braking pressure (S180). The final braking pressure may be determined by using Equation 3.

$$Final braking pressure = current braking pressure {P}_{current} + target braking pressure {P}_{target} \qquad [ Equation 3 ]$$

By maintaining the determined final braking pressure (S190), the vehicle can be controlled such that it does not roll on an uphill or downhill road. In this case, the final braking pressure may be maintained by detecting the final braking pressure through the braking pressure sensor 700.

The final braking pressure may be maintained until the emergency stop request signal is released (e.g., returned) (S200), for example, when the lead vehicle starts (e.g., starts moving from a stop) and the subject vehicle (e.g., the host vehicle) also starts (e.g., starts moving from a stop), or when the driver depresses the brake pedal and thus the smart cruise control function is released (e.g., disengaged).

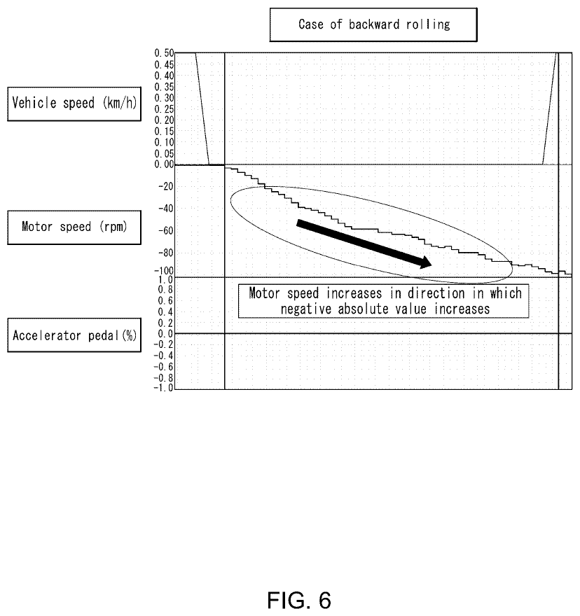

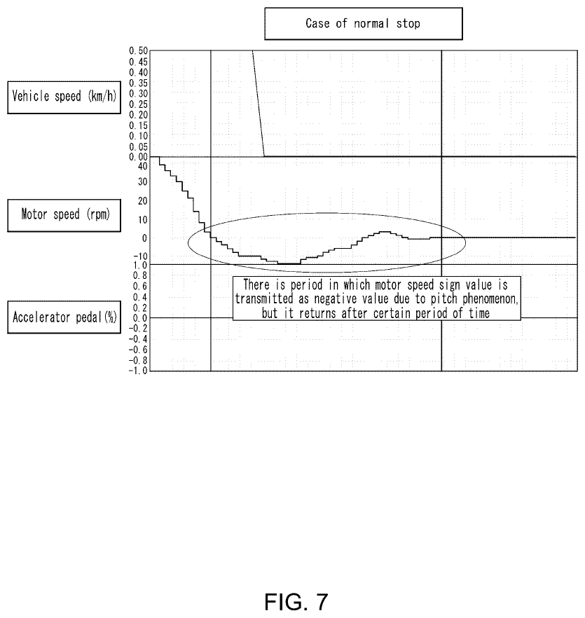

FIG. 6 and FIG. 7 show vehicle speeds, motor speeds, and accelerator pedal statuses when backward rolling occurs and when no backward rolling occurs. A negative speed value on the graphs of FIG. 6 and FIG. 7 indicate a speed in the negative (e.g., reverse) direction. In other words, if a vehicle has a negative speed value, the vehicle may be moving (e.g., rolling) backward. If the vehicle has a negative motor speed value, the motor (e.g., engine) may be turning in reverse.

In FIG. 6, when a vehicle stops on an uphill road, the vehicle speed becomes 0 (zero) and the accelerator pedal is not pressed, but the vehicle rolls and accelerates backward (e.g., in the reverse or rearward direction). Therefore, as shown, the motor speed increases in the negative (e.g., reverse) direction (e.g., the absolute value of the speed increases while the sign of the value stays minus)).

On the other hand, in FIG. 7, when the vehicle stops on a flat surface, the vehicle speed becomes 0 (zero) and the accelerator pedal is not pressed. When the vehicle stops, the motor speed becomes a negative value temporarily due to the pitch motion described above, but approaches 0 (zero) after a certain period of time.

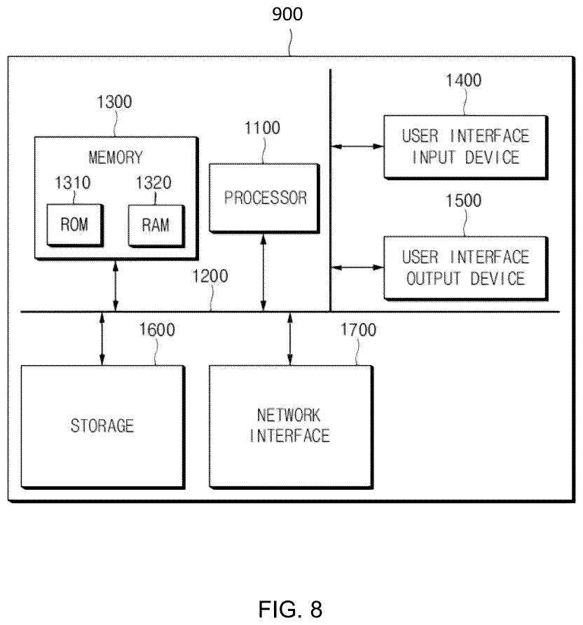

FIG. 8 shows an example computing system (e.g., a computing device of a vehicle or any other apparatus). One or more controllers, processors, etc. described herein may be implemented by the computing system or may be implemented in the computing system.

A computing system (also referred as a computer, a computing device, etc.) 900 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (i.e., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

To achieve these objects and other advantages and in accordance with the purpose of the disclosure, as embodied and broadly described herein, a method of braking an autonomous vehicle on a slope includes stopping the vehicle during smart cruise control (SCC) operation, determining whether slope rolling occurs in the vehicle, calculating a final braking pressure of the vehicle in which slope rolling occurs, and braking the vehicle with the final braking pressure.

The determining whether slope rolling occurs in the vehicle may include determining whether the vehicle is stopped on an uphill slope, determining whether a distance between the vehicle and a preceding vehicle increases, determining whether a signal value of a wheel sensor of the vehicle is valid, and determining whether a motor speed of the vehicle decreases in a negative direction and a signal of the wheel sensor is backward.

The determining whether the vehicle has stopped on an uphill road may include determining that the vehicle has stopped on an uphill road if an acceleration due to rolling of the vehicle is detected for 500 milliseconds or longer, and a gradient θ of the road on which the vehicle has stopped is greater than 0 degrees (°).

The determining whether the vehicle has stopped on an uphill road may include determining that the vehicle has stopped on an uphill road if an amount of change in a distance between the vehicle and an object in front of the vehicle is equal to or greater than a third value.

The vehicle may be determined to have stopped on an uphill road when the signal of the wheel sensor is backward and the signal of the wheel sensor is detected for 500 milliseconds or longer.

The vehicle may be determined to have stopped on an uphill road when the motor speed of the vehicle decreases in the negative direction and an amount of change in the motor speed is equal to or less than a fourth value.

The determining whether slope rolling occurs in the vehicle may include determining whether the vehicle is stopped on a downhill slope, determining whether a distance between the vehicle and a preceding vehicle decreases, determining whether a signal value of a wheel sensor of the vehicle is valid, and determining whether a motor speed of the vehicle decreases in a positive direction and a signal of the wheel sensor is forward.

The determining whether the vehicle has stopped on a downhill road may include determining that the vehicle has stopped on a downhill road if an acceleration due to rolling of the vehicle is detected for 500 milliseconds or longer, and a gradient θ of the road on which the vehicle has stopped is less than 0 degrees (°).

The determining whether the vehicle has stopped on a downhill road may include determining that the vehicle has stopped on a downhill road if an amount of change in a distance between the vehicle and an object in front of the vehicle is equal to or greater than a fifth value.

The vehicle may be determined to have stopped on a downhill road when the signal of the wheel sensor is forward and the signal of the wheel sensor is detected for a 500 milliseconds or longer.

The vehicle may be determined to have stopped on an uphill road when the motor speed of the vehicle increases in the positive direction and an amount of change in the motor speed is equal to or less than a sixth value.

The may further include transmitting an emergency stop request signal upon determining that slope rolling occurs in the vehicle.

The final braking pressure of the vehicle may be a sum of a current braking pressure of the vehicle and a target braking pressure.

The target braking pressure may be a product of an amount of change in a wheel speed of the vehicle, an amount of change in a distance from a preceding vehicle, and a proportional constant.

In another aspect of the present disclosure, an autonomous vehicle includes a wheel sensor configured to measure a rotation value of wheels, a front camera, a front radar, and a front-side radar configured to measure a distance from an object in front or on the front side of the vehicle, a motor sensor configured to measure a rotation value of a motor of an engine of the vehicle, a smart cruise controller configured to implement an SCC function of the vehicle and receive a measurement value of at least one of the front camera, the front radar, or the front-side radar, a rotation value measured by the wheel sensor, and a rotation value measured by the motor sensor, and a brake controller configured to receive an output value from the smart cruise controller and calculate a target braking pressure of the vehicle.

The brake controller may brake the vehicle with a final braking pressure when slope rolling occurs in the stopped vehicle, and set the final braking pressure as a sum of a current braking pressure of the vehicle and a target braking pressure.

Another aspect of the present disclosure provides a program recorded on a computer-readable recording medium and executed by a processor to perform a method of braking an autonomous vehicle on a slope.

Also provided is a computer-readable recording medium on which the above-described program is recorded.

It is to be understood that both the foregoing general description and the following detailed description of the present disclosure are exemplary and explanatory and are intended to provide further explanation of the disclosure as claimed.

The autonomous vehicle and the autonomous driving method of the vehicle as described herein can prevent a rear-end collision by performing emergency braking when the vehicle stops on a slope while driving by smart cruise control and thus rolls forward or backward. In addition, by determining a target braking pressure variably in proportion to the amount of change in a distance to a lead vehicle and the amount of change in the wheel speed, it is possible to provide an optimal braking pressure depending on the degree of rolling. Furthermore, only when the vehicle rolling is 500 milliseconds (ms) or longer, it is determined as a valid value, and the rolling is distinguished from a pitch motion. Further, only when the signal value of the wheel sensor or the amount of change in the motor speed of the engine is the third to sixth values or more, it is determined that the vehicle has stopped on an uphill or downhill road. Accordingly, cases such as vehicle rolling below a certain threshold can be excluded.

According to the autonomous vehicle and the autonomous driving method of a vehicle of the present disclosure described herein, when the vehicle stops on a slope while traveling by smart cruise control and rolls forward or backward, emergency braking can be performed to prevent collision.

Even though all the components constituting the example embodiment(s) of the present disclosure have been described as being combined as one or operating in combination, the present disclosure is not necessarily limited to these embodiments. That is, within the scope of the purpose of the present disclosure, one or more of the components may be selectively combined and operated. In addition, the term “comprise”, “include”, or “have” described herein should be interpreted not to exclude other elements but to further include such other elements since the corresponding elements may be included unless mentioned otherwise. All terms including technical or scientific terms have the same meanings as generally understood by a person having ordinary skill in the art to which the present disclosure pertains unless mentioned otherwise. Generally used terms, such as terms defined in a dictionary, should be interpreted to coincide with meanings of the related art from the context. Unless differently defined in the present disclosure, such terms should not be interpreted in an ideal or excessively formal manner.

The above description is merely an exemplary description of the technical idea of the present disclosure, and those skilled in the art to which the present disclosure pertains may make various modifications and variations without departing from the essential characteristics of the present disclosure. Accordingly, the example embodiment(s) of the present disclosure are not intended to limit the technical idea of the present disclosure but to explain the same, and the scope of the technical idea of the present disclosure is not limited by these example embodiment(s). The scope of protection of the present disclosure should be interpreted by the claims below, and all technical ideas within the equivalent scope should be interpreted as being included in the scope of the rights of the present disclosure.

What is claimed is:

1. A method performed by an apparatus of a first vehicle, the method comprising:
detecting a roll down of the first vehicle that stopped while adaptive cruise control of the first vehicle is engaged, wherein the detecting of the roll down is based on at least one of:
whether the first vehicle stops on an uphill slope;
whether a distance, between the first vehicle and a second vehicle in front of the first vehicle, increases;
whether a signal of a wheel sensor of the first vehicle is detected; or
whether an absolute value of a negative motor speed of the first vehicle increases and whether the signal of the wheel sensor indicates a rearward movement of the first vehicle;
determining, based on the detecting of the roll down of the first vehicle, a braking pressure for the first vehicle; and
controlling the first vehicle to brake according to the determined braking pressure.

2. The method of claim 1, wherein the detecting of the roll down of the first vehicle comprises:
while a brake pedal of the first vehicle is not depressed by a driver of the first vehicle, determining that the first vehicle has stopped on the uphill slope based on:
an acceleration of the first vehicle being detected for at least a threshold time duration; and
a gradient of a road on which the first vehicle has stopped is greater than 0 degrees.

3. The method of claim 1, wherein the detecting of the roll down of the first vehicle comprises:
determining that the first vehicle has stopped on the uphill slope based on:
an amount of change in a distance between the first vehicle and the second vehicle being greater than or equal to a threshold value.

4. The method of claim 1, wherein the detecting of the roll down of the first vehicle comprises:
determining that the first vehicle has stopped on the uphill slope based on:
the signal of the wheel sensor indicating the rearward movement of the first vehicle and the signal of the wheel sensor being detected for at least a threshold time duration.

5. The method of claim 1, wherein the detecting of the roll down of the first vehicle comprises:
determining that the first vehicle has stopped on the uphill slope based on:
the absolute value of the negative motor speed of the first vehicle increasing and an amount of change in the motor speed being less than or equal to a threshold value.

6. The method of claim 1, further comprising transmitting, based on the detecting of the roll down of the first vehicle, an emergency stop request signal.

7. The method of claim 1, wherein the braking pressure of the first vehicle is a sum of a current braking pressure of the first vehicle and a target braking pressure.

8. The method of claim 7, wherein the target braking pressure is a product of an amount of change in a wheel speed of the first vehicle, an amount of change in a distance between the first vehicle and the second vehicle, and a proportional constant.

9. A method performed by an apparatus of a first vehicle, the method comprising:
detecting a roll down of the first vehicle that stopped while adaptive cruise control of the first vehicle is engaged, wherein the detecting of the roll down is based on at least one of:
whether the first vehicle stops on a downhill slope;
whether a distance, between the first vehicle and a second vehicle in front of the first vehicle, decreases;
whether a signal of a wheel sensor of the first vehicle is detected; or
whether a motor speed of the first vehicle increases and whether the signal of the wheel sensor indicates a forward movement of the first vehicle;
determining, based on the detecting of the roll down of the first vehicle, a braking pressure for the first vehicle; and
controlling the first vehicle to brake according to the determined braking pressure.

10. The method of claim 9, wherein the detecting of the roll down of the first vehicle comprises:
while a brake pedal of the first vehicle is not depressed by a driver of the first vehicle, determining that the first vehicle has stopped on the downhill slope based on:
an acceleration of the first vehicle being detected for at least a threshold time duration; and
a gradient of a road on which the first vehicle has stopped is less than 0 degrees.

11. The method of claim 9, wherein the detecting of the roll down of the first vehicle comprises:
determining that the first vehicle has stopped on the downhill slope based on:
an amount of change in a distance between the first vehicle and the second vehicle being greater than or equal to a threshold value.

12. The method of claim 9, wherein the detecting of the roll down of the first vehicle comprises:
determining that the first vehicle has stopped on the downhill slope based on:
the signal of the wheel sensor indicating the forward movement of the first vehicle and the signal of the wheel sensor being detected for at least a threshold time duration.

13. The method of claim 9, wherein the detecting of the roll down of the first vehicle comprises:
determining that the first vehicle has stopped on the downhill slope based on:
the motor speed of the first vehicle increasing and an amount of change in the motor speed being less than or equal to a threshold value.

14. The method of claim 9, further comprising transmitting, based on the detecting of the roll down of the first vehicle, an emergency stop request signal.

15. The method of claim 9, wherein the braking pressure of the first vehicle is a sum of a current braking pressure of the first vehicle and a target braking pressure.

16. The method of claim 15, wherein the target braking pressure is a product of an amount of change in a wheel speed of the first vehicle, an amount of change in a distance between the first vehicle and the second vehicle, and a proportional constant.

17. An autonomous vehicle comprising:
a wheel sensor configured to measure a wheel rotational speed of wheels of the autonomous vehicle;
a front camera, a front radar, and a front-side radar configured to measure a distance from the autonomous vehicle to an object in front of the autonomous vehicle, wherein the object is in a same driving lane or in an adjacent driving lane as the autonomous vehicle;
a motor sensor configured to measure a motor rotational speed of a motor of the autonomous vehicle;
an adaptive cruise control system configured to:
maintain a distance between the autonomous vehicle and the object; and
receive a measurement value of at least one of the front camera, the front radar, or the front-side radar, the wheel rotational speed, and the motor rotational speed; and
a brake controller configured to receive an output value from the adaptive cruise control system and determine a target braking pressure of the autonomous vehicle to control a roll down of the autonomous vehicle.

18. The autonomous vehicle of claim 17, wherein the brake controller is further configured to:
apply, based on the roll down of the autonomous vehicle being detected after the autonomous vehicle has stopped, braking to the autonomous vehicle with an adjusted braking pressure, and
wherein the adjusted braking pressure is a sum of a current braking pressure of the autonomous vehicle and the target braking pressure.

19. The autonomous vehicle of claim 18, wherein the adaptive cruise control system is further configured to:
detect the roll down of the autonomous vehicle by determining that the autonomous vehicle has stopped on an uphill slope based on:
an acceleration of the autonomous vehicle being detected for at least a threshold time duration; and
a gradient of a road on which the autonomous vehicle has stopped is greater than 0 degrees.

20. The autonomous vehicle of claim 18, wherein the adaptive cruise control system is further configured to:
detect the roll down of the autonomous vehicle by determining that the autonomous vehicle has stopped on a downhill slope based on:
an acceleration of the autonomous vehicle being detected for at least a threshold time duration; and
a gradient of a road on which the autonomous vehicle has stopped is less than 0 degrees.
